(19) United States
(12) Patent Application Publication
(10) Pub. No.: US 2026/0369038 A1
(43) Pub. Date: Nov. 19, 2026

(54) UTILIZING VECTOR-BASED CONTENT RETRIEVAL AND GENERATIVE ARTIFICIAL INTELLIGENCE (AI) MODELS FOR IMPROVED CONTENT MODERATION

(71) Applicant: Microsoft Technology Licensing, LLC, Redmond, WA (US)

(72) Inventors: Madhu RAMANATHAN, San Jose, CA (US); Ahmed Bahaaeldin MOHAMED, Cairo (EG); Sara Ahmed Mohamed ABDELGHAFFAR, Damietta (EG); Mohamed Farouk ABDELHADY, Redmond, WA (US)

(21) Appl. No.: 19/212,383

(22) Filed: May 19, 2025

(51) Int. Cl. G06V 10/764; G06F 16/532; G06F 16/535; G06F 16/55; G06V 20/70

(52) U.S. Cl. CPC G06V 10/764; G06F 16/532; G06F 16/535; G06F 16/55; G06V 20/70

(57) ABSTRACT

This disclosure describes a content moderation system that provides a multi-stage framework utilizing generative artificial intelligence (AI) models and vector-searching of multimodal embeddings to improve the accuracy and reliability of content moderation. For example, the multi-stage framework includes content moderation enhancements such as content retrieval, relevance refinement, content classification, classification model training, and real-time classification model inference. As a result, the content moderation system can deliver real-time protection against providing regulated content in response to content retrieval requests. For instance, the content moderation system serves as an image moderation system that utilizes the multi-stage framework to protect against providing prohibited images to users and restricted images to unauthorized users.

### BACKGROUND

In recent years, there have been significant advancements in both hardware and software domains, specifically in the field of internet search. Some current internet search systems are designed to search for and retrieve images. However, existing systems still struggle with filtering out prohibited images. This problem increases as the number of available images continues to grow. These and other issues persist in current search result systems.

### BRIEF DESCRIPTION OF THE DRAWINGS

The following detailed description provides specific implementations accompanied by drawings. Additionally, each of the figures listed below corresponds to one or more implementations discussed in this disclosure.

FIG. 1 illustrates an example overview of an image moderation system that utilizes generative artificial intelligence (AI) models and embeddings to generate a labeled training dataset that includes regulated images.

FIG. 2 illustrates an example computing environment where the image moderation system is implemented.

FIG. 3 illustrates an example overview of a multi-stage framework for generating a labeled training dataset using various generative AI models.

FIG. 4 illustrates an example diagram for generating a vector embedding database utilizing a generative AI model, an image search system, and an embedding encoder.

FIG. 5 illustrates an example diagram for determining the top relevant regulated images based on image search results of prohibited images and image search queries.

FIG. 6 illustrates an example diagram for generating labeled data using a visual-based generative AI model.

FIGS. 7A-7B illustrate example diagrams for training and utilizing a classification machine learning model based on the labeled training dataset.

FIGS. 8A-8B illustrate an example series of acts of computer-implemented methods for generating one or more content classification datasets using one or more AI models.

FIG. 9 illustrates example components included within a computer system utilized to implement the image moderation system.

### DETAILED DESCRIPTION

This disclosure describes a content moderation system that provides a multi-stage framework utilizing generative artificial intelligence (AI) models and vector-searching of multimodal embeddings to improve the accuracy and reliability of content moderation. For example, the multi-stage framework includes content moderation enhancements such as content retrieval, relevance refinement, content classification, classification model training, and real-time classification model inference. As a result, the content moderation system can deliver real-time protection against providing regulated content in response to content retrieval requests. For instance, the content moderation system serves as an image moderation system that utilizes the multi-stage framework to protect against providing prohibited images to users and restricted images to unauthorized users.

Implementations of the present disclosure provide benefits and solve problems of conventional systems by providing systems, computer-readable media, and computer-implemented methods that utilize a content moderation system, largely described in the context of an image moderation system, to generate improved training datasets that provide improved reliability and accuracy when detecting regulated content provided to users. For example, the content moderation system utilizes a framework that combines generative AI models, multimodal embedding encoder models, vector embeddings, and visual-based generative AI models to create rich, robust, and complete training datasets. The content moderation system can then utilize these training datasets to train and utilize classification machine learning models to detect regulated content in real time.

To provide additional context, in the field of machine learning and computer vision, the accuracy and reliability of model training heavily depend on the quality, diversity, and other desired characteristics of the training data. For example, in image retrieval, an image search index can serve as a vital tool for sourcing and curating a wide range of images that accurately represent the various classes and categories that a classification model is trained to recognize. An image search index can provide a vast repository of images in an attempt to provide training data that is representative of real-world scenarios.

However, many existing image retrieval systems that utilize current image search indexes suffer from frequent occurrences of false positives (FP) and false negatives (FN) in classification models trained on these image search indexes. For example, many existing systems allow prohibited images to be included while also blocking images that should be permitted or allowed. In many instances, this inaccuracy is due to current image search indexes used to train the models lack completeness. For instance, many image search indexes are built based on previous user queries to better represent real-world scenarios. However, this approach causes many prohibited image types and several restricted image types to be missing from the index, making it a poor training tool for image moderation.

Moreover, in some instances, the images in an image search index are mislabeled. For example, content items (e.g., images) included in a document (e.g., a website or news article) are often associated with the subject matter of the document, but correlating the two may result in the content item being inaccurately labeled. For example, many articles about mental health conditions include neutral images, but these neutral images may be labeled as containing restricted mental health content.

Some image retrieval systems attempt to circumvent the issue of using poorly trained classification models by using generative AI models, such as large generative models (LGMs). However, many LGMs have higher latency, resulting in long wait times. The latency can become even longer when sharing a waiting queue with requests to be processed. Furthermore, LGMs require large amounts of computing resources. The limited capacity and latency of LGMs prevent existing systems from using LGMs in real-time to classify images and other retrieved content. Similarly, many current LGMs are too constrained to generate a robust training dataset.

In contrast, the content moderation system can address these and other issues of existing systems using the multi-stage framework it provides. For example, an image moderation system generates an improved image classification training dataset using one or more artificial intelligence models in connection with additional models and actions.

To illustrate, in various implementations, the image moderation system provides a search query generation prompt to a generative AI model to generate a set of image search queries based on a regulated image policy. In particular, the image moderation system causes the generative AI model to create image search queries that identify images that have regulated image classifications and that may be underrepresented in datastores (e.g., image search indexes). The image moderation system can provide the set of image search queries to an image search system to identify sets of images corresponding to each of the image search queries. Furthermore, the image moderation system can generate a vector embedding database that includes vector embeddings generated from the sets of images and from the image datastore.

Upon generating the vector embedding database, the image moderation system can identify a set of relevant images with regulated image classifications by comparing search query embeddings of the set of image search queries with the vector embeddings in the vector embedding database. The image moderation system can also generate a training dataset of images by combining a random image subset with the set of relevant images. Using the training dataset, in various implementations, the image moderation system can provide a classification prompt to a visual-based generative AI model to determine new classification labels for the images in the training dataset. Furthermore, the image moderation system can use the labeled training dataset to train a classification machine learning model, which is then used to filter out regulated images in real time.

As described in this disclosure, the image moderation system delivers several significant technical benefits in terms of improved computing accuracy, efficiency, and flexibility compared to existing search retrieval systems. Moreover, the image moderation system provides several practical applications that address problems related to providing safe and reliable search results in response to search queries.

To illustrate, in various implementations, the image moderation system improves computing efficiency and accuracy by selectively using generative AI models to generate robust and unbiased training datasets. In various implementations, the image moderation system utilizes a generative AI model to create image search query prompts to identify regulated content (e.g., prohibited and restricted content) as well as to reclassify images in a curated image collection (which includes positively identified images, such as regulated images). In various implementations, the image moderation system can utilize generative AI models when model demand is low, such as during off-peak times. By selectively using generative AI models, the image moderation system efficiently utilizes the generative AI model while avoiding limited capacity constraints or latency issues that commonly occur when using generative AI models for more general tasks.

In various implementations, the image moderation system selectively utilizes a generative AI model to target regulated images (e.g., prohibited and restricted images) or other content not included in an image datastore. For instance, the image moderation system utilizes the generative AI model to create image search queries, which are executed by an image search system to retrieve regulated images. Furthermore, to improve computing efficiency and accuracy, the image moderation system removes noisy content from the retrieved regulated images by using vector comparisons between the retrieved regulated images and the image search queries.

Additionally, the image moderation system utilizes a generative AI model, such as a visual-based generative AI model, to generate unbiased classifications for the filtered regulated images and images from an image database. By doing so, the image moderation system reduces the cost of using generative AI model inference for knowledge distillation, as generative AI models are selectively applied to a reduced list of candidate images or other filtered content. In this way, the image moderation system can efficiently use generative AI models for content moderation.

In various implementations, the image moderation system provides improved computing accuracy and flexibility. For instance, the image moderation system allows for improved content moderation by significantly reducing false positives and false negatives. The image moderation system also supports multimodal and multilingual vector-based searching, allowing for more accurate and diverse content moderation applications. For example, vector-base searching enables the use of different data sources, various image or text encoders, and diverse similarity measures when creating a robust training dataset. In various implementations, the image moderation system can also insert additional filters when identifying relevant content to improve the precision of the returned content.

Furthermore, based on an improved and robust training dataset, with accurate and unbiased labels provided by a generative AI model, the image moderation system can train an improved classification machine learning model. In this way, the image moderation system performs content moderation accurately using a lightweight classification model that determines improved real-time content classifications.

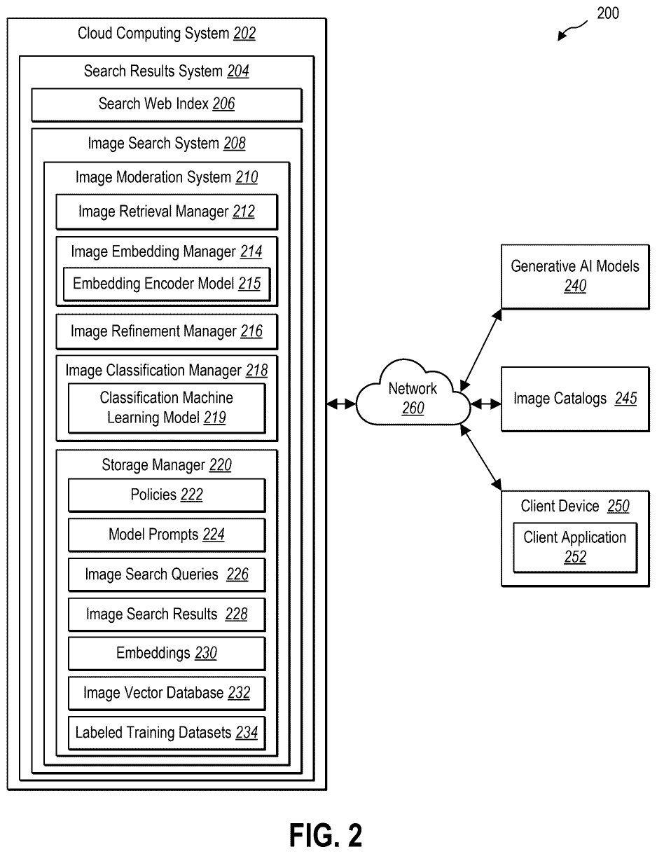

As illustrated in the preceding discussion, this disclosure uses a variety of terms to describe the features and advantages of one or more described implementations. For instance, this disclosure describes the image moderation system within the context of a cloud computing system. As an example, the term “cloud computing system” refers to a network of interconnected computing devices that provide various services and applications to computing devices (e.g., server devices and client devices) inside or outside the cloud computing system. An example of a cloud computing system is described below in connection with FIG. 2.

As an example, the term “regulated content” refers to content that is deemed permissible or non-permissible to provide to specific users based on a regulated content policy. For example, regulated images can include images prohibited by a regulated image policy (e.g., not to be provided to any audience) and/or restricted images that are intended for only approved audiences. For instance, restricted images can include images unsuitable or distressing for young viewers or images improper or inappropriate for formal environments. In various implementations, regulated content is identified based on violations of conditions in a regulated content policy and/or being classified into a regulated content classification, as further described below.

As an example, a “generative artificial intelligence (AI) model” is an artificial intelligence system that utilizes deep learning and a large number of parameters (e.g., in the billions or trillions), which are trained and/or fine-tuned on one or more extensive datasets to produce coherent, contextually relevant, and fluently topic-specific outputs (e.g., text and/or images). In many instances, a generative model refers to an advanced computational system that uses natural language processing, machine learning, and/or image processing to generate coherent and contextually relevant human-like responses.

Generative AI models (both large and small) have applications in natural language understanding, content generation, text summarization, dialogue systems, language translation, creative writing assistance, image generation, audio generation, and more. A single generative AI model often performs a wide range of tasks by receiving different inputs, such as prompts (e.g., input instructions, rules, example inputs, example outputs, and/or tasks), data, and/or access to data. In response, the generative AI model generates various output formats, ranging from comprehensive generative summaries and visual digests of several types to direct answer generative documents.

Moreover, generative AI models are primarily based on transformer architectures for understanding, generating, and manipulating human language. Generative AI models can also utilize other types of architectures, such as recurrent neural networks (RNNs), long short-term memory (LSTM) models, convolutional neural networks (CNNs), or other architectures. Examples of generative AI models include generative pre-trained transformer (GPT) models like GPT-3.5, GPT-4, and GPT-4o, bidirectional encoder representations from transformers (BERT) models, text-to-text transfer transformer models like T5, conditional transformer language (CTRL) models, and Turing-NLG. Other types of generative AI models include sequence-to-sequence models (Seq2Seq), vanilla RNNs, and LSTM networks. In some instances, a generative AI model includes a large generative AI model (LGM), a small generative AI model (SGM), a large language model (LLM), a small language model (SLM), and a small action model (SAM), which serve as text-based versions of generative AI models that receive text prompts and/or generate text outputs. In various implementations, a generative AI model is a multimodal generative model that receives multiple input formats (e.g., text, images, video, and data structures) and/or generates multiple output formats.

As an example, the terms “prompt,” “model prompt,” or “generative AI model prompt” refer to a request made to a generative AI model to create a generative output based on plain language guidance. In some instances, the suggestion item system provides additional information along with a prompt. A prompt can include important contextual information and/or general framing information to ensure that the generative AI model understands the correct context, syntax, and grounding information of the data it is processing. Examples of prompts, such as search query generation prompts and content classification prompts, are provided below.

As an example, the term “visual-based generative AI model” refers to a generative AI model that receives an image as input and provides visual context information as output. The visual context information is often provided as text, such as a sentence, a paragraph, and/or a list of items. In some instances, a visual-based generative AI model uses a combination of convolutional neural networks (CNNs) and transformers to generate high-quality visual content and/or extract visual features from an input image. In various implementations, a visual-based generative AI model generates output based on provided prompts. For instance, a visual-based generative AI model classifies images into a set of classes included in a prompt.

As an example, the term “lightweight model” refers to a compact and resource-efficient model that is trained to perform a specific task while achieving a balance between accuracy and computational cost. While a generative AI model is trained on vast datasets to solve a wide range of tasks, a lightweight model is often targeted to one or a few tasks. In various implementations, a lightweight model is a machine learning model. In some implementations, a lightweight model is a heuristics-based or algorithmic model. Lightweight models are designed to perform specific tasks while minimizing memory usage, inference time, and energy consumption. Lightweight models use significantly fewer parameters and computing processing resources than many generative AI models to provide outputs.

Implementation examples and details of the image moderation system are discussed in connection with the accompanying figures, which are described next. Notably, while this disclosure corresponds to a content moderation system to generate a robust training dataset of content items, many of the figures are described in terms of an image moderation system. While an image moderation system is described, the same principles, methods, approaches, and actions apply to other types of content.

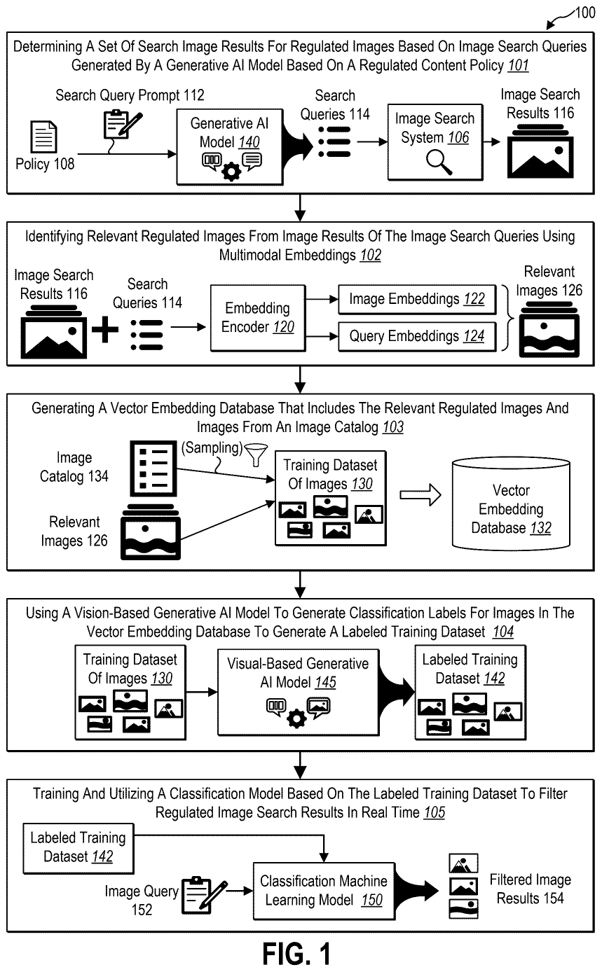

As illustrated, FIG. 1 shows an example overview of an image moderation system using generative artificial intelligence (AI) models and embeddings to generate a labeled training dataset that includes regulated images according to some implementations. While FIG. 1 provides a high-level overview of the invention, additional details are provided in subsequent figures.

FIG. 1 illustrates a series of acts 100 performed by or following directions from the image moderation system. As shown, the series of acts 100 briefly illustrates an example of how the image moderation system uses multiple generative AI models, an embedding encoder, and a vector embedding database to create a labeled training dataset. Furthermore, based on the labeled training dataset, the image moderation system trains a classification machine learning model to perform real-time content moderation.

As mentioned above, many current training datasets rely on image search indexes (e.g., image catalogs) to train classification models. However, many image search indexes lack adequate examples of prohibited images and other types of regulated images. Accordingly, when used for generating training data, these image search indexes are incomplete, resulting in poorly performing classification models. To address these shortcomings, the image moderation system begins by obtaining image sets of prohibited images, restricted images, and/or other underrepresented images in an image catalog.

To illustrate, the series of acts 100 includes act 101 determining a set of search image results for regulated images based on image search queries generated by a generative AI model according to a regulated image policy. In one or more implementations, the image moderation system obtains a set of image search results for prohibited images by first providing a policy 108 (e.g., a regulated image policy) to a generative AI model 140 along with a search query prompt 112 that instructs the model to analyze the policy 108 to determine regulated image classes and generate search queries 114 to identify images belonging to these regulated image classes.

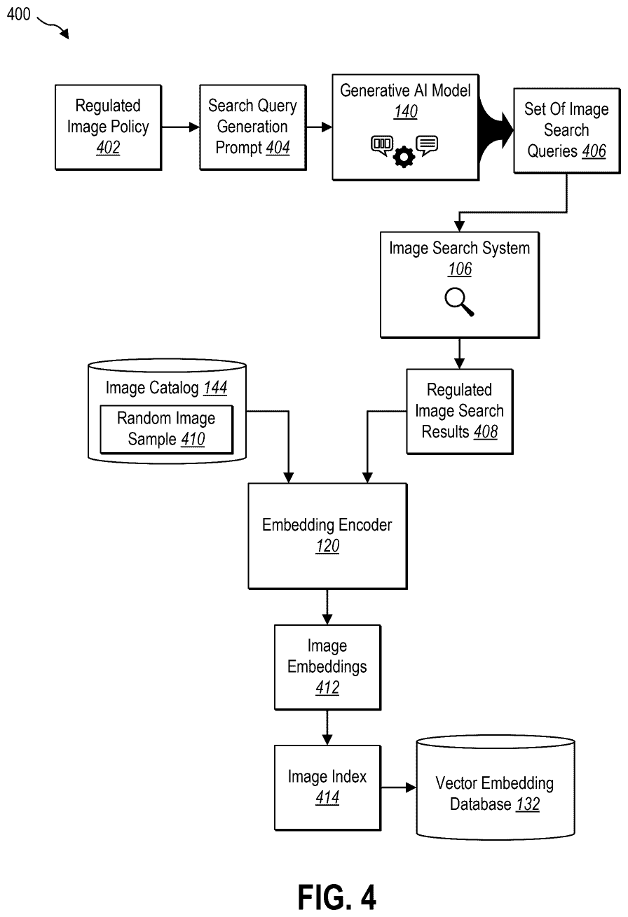

In various implementations, the image moderation system provides the search queries 114 to an image search system 106, which executes the search queries 114 to retrieve image search results 116 of the regulated images (e.g., sets of different prohibited image classes). Additional details about using a generative AI model and an image search system to retrieve regulated images are provided below in connection with FIG. 4.

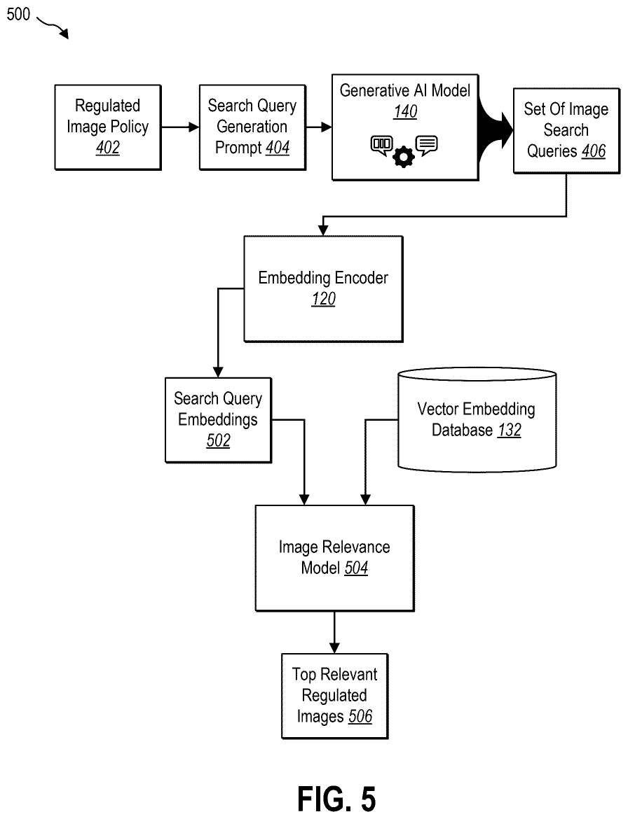

Act 102 includes identifying relevant related images from the image search results of the image search queries using multimodal embeddings. In many instances, the image search results 116 include unrelated images and other noise. Accordingly, in various implementations, the image moderation system compares embeddings of the image search results 116 with embeddings of the search queries 114 to filter out irrelevant images. In particular, using an embedding encoder 120 (e.g., a multimodal embedding encoder model), the image moderation system generates image embeddings 122 from the image search results 116 and query embeddings 124 from the search queries 114, and compares proximity between the two embedding groups to identify relevant images 126 and remove noisy images. Additional details about using multimodal embeddings to determine relevant regulated retrieved images are provided below in connection with FIG. 5.

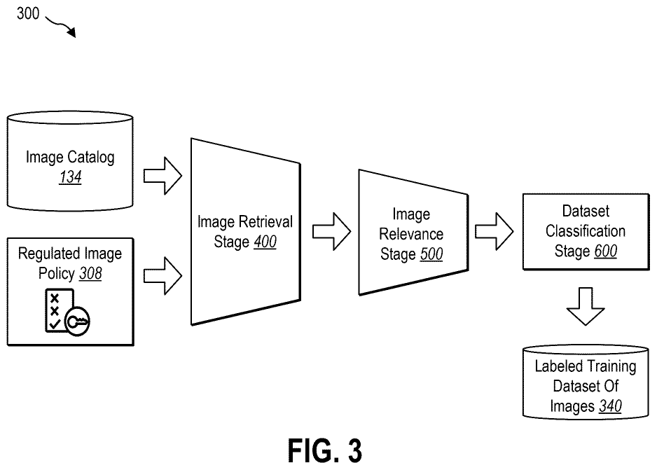

Act 103 includes generating a vector embedding database that includes the relevant regulated images and images from an image catalog. In various implementations, the image moderation system supplements images in an image catalog 134 with the relevant images 126 to generate a training dataset of images 130. In some instances, the image moderation system samples a random selection of images from the image catalog 134 to combine with the relevant images 126. Furthermore, in some instances, the image moderation system generates a vector embedding database 132 from the training dataset of images 130. Additional details regarding the generation of a vector embedding database of a training dataset with regulated images are provided below in connection with FIG. 3 and FIG. 4.

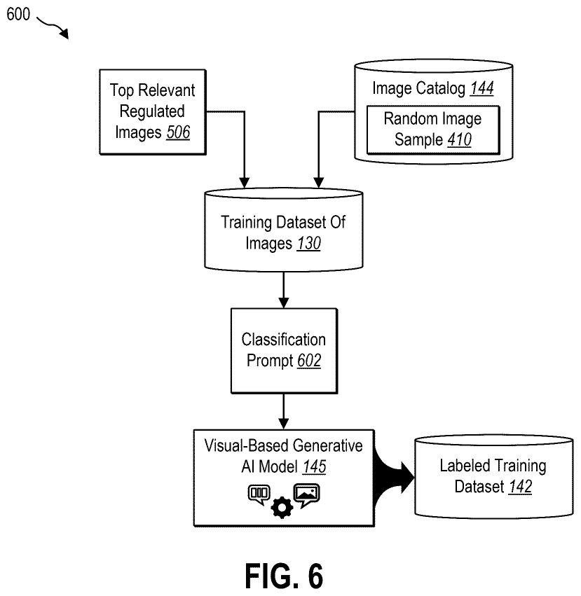

Act 104 includes using a visual-based generative AI model to generate classification labels for images in the vector embedding database to generate a labeled training dataset. In various implementations, the image moderation system provides the training dataset of images 130 to a visual-based generative AI model 145 with a classification prompt for the model to classify each image in the dataset as either a regulated or non-regulated image. Using the generated classifications, the image moderation system can generate a labeled training dataset 142. Additional details about using a visual-based generative AI model to generate labeled training datasets are provided below in connection with FIG. 6.

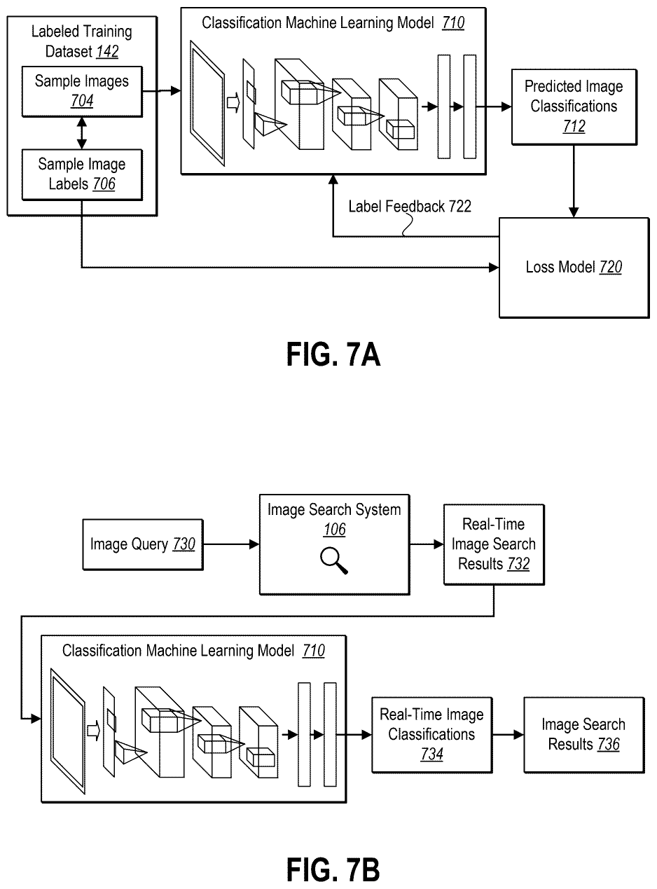

Act 105 includes training and utilizing a classification model based on the labeled training dataset to filter regulated image search results in real time. Using the improved training dataset, which includes regulated images and updated labels, the image moderation system can train a classification machine learning model 150, which is often a lightweight model. Then, using the classification machine learning model 150, the image moderation system can filter out images in response to an image query 152 to provide filtered image results 154 that have removed or authorized regulated images. Additional details about training and using classification machine learning models based on labeled training datasets are provided below in connection with FIGS. 7A-7B.

With a general overview in place, additional details are provided regarding the components, features, and elements of the image moderation system. To illustrate, FIG. 2 shows an example computing environment in which the image moderation system is implemented according to some implementations. In particular, FIG. 2 illustrates an example of a computing environment 200 with various computing devices, including a cloud computing system 202 associated with an image moderation system 210. While FIG. 2 shows example arrangements and configurations of the computing environment 200, the cloud computing system 202, the image moderation system 210, and associated components, other arrangements and configurations are possible.

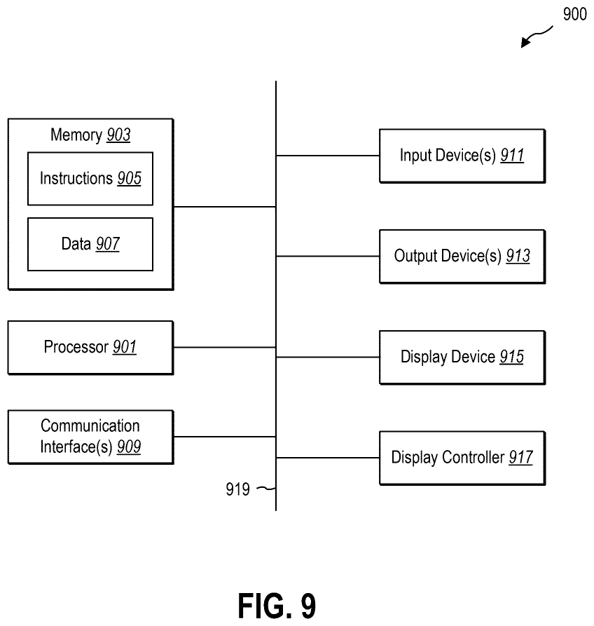

As shown, the computing environment 200 includes a cloud computing system 202 associated with the image moderation system 210, generative AI models 240, image catalogs 245, and a client device 250 with a client application 252, connected via a network 260. Many of these components may be implemented on one or more computing devices, such as one or more server devices, while some components may be implemented on personal devices. Further details regarding computing devices are provided below in connection with FIG. 9, along with additional details regarding networks, such as the network 260 shown.

Before describing the components of the cloud computing system 202, including the image moderation system 210, other components of the computing environment 200 are discussed first to provide better context for the image moderation system 210. As shown, the computing environment 200 includes the generative AI models 240, which correspond to one or more generative models tuned to efficiently perform various operations. The generative AI models 240 can include small generative AI models (SGMs) and/or large generative AI models (LGMs).

In some implementations, the generative AI models 240 include a generative AI model that generates content search queries (e.g., image search queries) from regulated content policies (e.g., regulated image policies). In some implementations, the generative AI models 240 include a visual-based generative AI model. For instance, a visual-based generative AI model analyzes the visual content and features of an image to generate visually influenced output according to an input prompt. In some instances, the image moderation system obtains image classifications using a visual-based generative AI model.

The cloud computing system 202 also includes the image catalogs 245. In various implementations, the image catalogs 245 include image datastores of collected images. In various implementations, an image catalog does not include a representative number of prohibited images. In some instances, an image catalog includes some regulated images, such as restricted images. In other instances, an image catalog does not include any type of regulated images, or the included regulated images are underrepresented compared to the distribution of non-regulated images.

As shown, the computing environment 200 includes the client device 250. In various implementations, the client device 250 is associated with a user (e.g., a user client device) who requests a search query. In various instances, the client device 250 includes a client application 252, such as a web browser, mobile application, or another form of software application for accessing and/or interacting with the cloud computing system 202, search results system, an image search system, and/or the image moderation system 210. For example, the client device 250 interacts with a search results system to obtain image results, and the image moderation system 210 aids in ensuring that the results do not violate regulated image policies.

Returning to the cloud computing system 202, as shown, the cloud computing system 202 includes a search results system 204. In various implementations, the search results system 204 provides search results in response to a search query. For example, the client device 250 submits a search request, and the search results system 204 returns search results in the form of links or other content (e.g., images, text, videos, animations, and files). In various implementations, the search results system 204 utilizes a search web index 206 to identify search results.

In addition, the search results system 204 includes an image search system 208, which searches and retrieves images in response to image-based search requests. While not shown, the search results system 204 may include other types of content search systems, with each having a corresponding content moderation system.

As illustrated, the image search system 208 utilizes the image moderation system 210, which includes various components and elements implemented in hardware and/or software. For example, the image moderation system 210 includes an image retrieval manager 212, an image embedding manager 214 with an embedding encoder model 215, an image refinement manager 216, an image classification manager 218 with a classification machine learning model 219, and a storage manager 220. The storage manager 220 includes policies 222, model prompts 224, image search queries 226, image search results 228, embeddings 230, image vector databases 232, and labeled training datasets 234.

As mentioned, the image moderation system 210 includes the image retrieval manager 212, which facilitates obtaining image search results 228 corresponding to regulated images (e.g., prohibited or restricted images). For example, the image retrieval manager 212 provides model prompts 224 to a generative AI model from the generative AI models 240 to generate image search queries 226 from policies 222 (e.g., content regulation policies). The image retrieval manager 212 then utilizes the search results system 204 to execute the image search queries 226 to obtain the image search results 228.

In various implementations, the image retrieval manager 212 also includes images from the image catalogs 245. For example, the image retrieval manager 212 retrieves a random sampling of images from an image catalog. The image retrieval manager 212 can combine the retrieved sample of images with retrieved search images that correspond to one or more regulated classes. In various implementations, the image moderation system 210 samples images within a recent time period (e.g., 1 month, 3 months, 6 months, 1 year, or 2 years) and/or across the sampling period.

The image moderation system 210 includes the image embedding manager 214, which generates embeddings 230 using an embedding encoder model 215 from the image search results 228 and the image search queries 226. In various implementations, some of the embeddings 230 are used to generate an image vector database, as described below.

Additionally, the image moderation system 210 includes the image refinement manager 216. Using the embeddings 230, the image moderation system 210 can determine relevant images from the image search results 228. In some implementations, the image embedding manager 214 generates embeddings of images retrieved from the image catalogs 245, and the image refinement manager 216 determines which of those images are relevant based on semantic similarities with embeddings of the image search queries 226. For example, the image refinement manager 216 can generate a training dataset with the sampled images and/or the refined images.

In various implementations, the image refinement manager 216 utilizes a visual-based generative AI model from the generative AI models 240 to classify images in a training dataset. For example, the image refinement manager 216 provides policies 222 (e.g., classification prompts) to the visual-based generative AI model to generate labels from the training dataset. The image refinement manager 216 then applies the generated labels to the training data to generate training datasets 234.

The image moderation system 210 includes the image classification manager 218 with the classification machine learning model 219. In various implementations, the image classification manager 218 utilizes the training datasets 234 to train the classification machine learning model 219 to accurately and robustly classify images in real time in response to user image search queries.

Turning to the next set of figures, FIGS. 3-6 provide additional details regarding the generation of a robust labeled training dataset using various generative AI models and other machine learning model models. To illustrate, FIG. 3 shows an example overview of a multi-stage framework for generating a labeled training dataset using various generative AI models according to some embodiments. In particular, FIG. 3 includes a multi-stage framework 300, shown presented a high level, for generating a labeled training dataset of images 340.

As shown, the pipeline begins with the image catalog 134 and a regulated image policy 308. As mentioned, the image catalog 134 may include images obtained from previous image search queries. In these instances, the image catalog 134 represents real-world distributions of retrieved images. In some implementations, the image catalog 134 is a collection of images that have different distributions. In most implementations, the image catalog 134 does not include a representative distribution of regulated images (e.g., prohibited and/or restricted images).

In various implementations, the regulated image policy 308 includes rules, conditions, criteria, and/or guidelines for determining what types of content and images should be regulated. To illustrate, Listing 1 below provides an example regulated image policy related to restricted adult content. Note that, due to of the adult context of the policy, portions of the policy are paraphrased or excluded:
Restricted adult content is material that is considered inappropriate for high visibility in feeds, unsuitable for young viewers, or improper for formal environments. While it is not explicit, graphic, or dangerous, it maintains a level of impropriety. This policy adds nuance and enables a better user experience according to users' preference for cold feeds and warm feeds.
Restricted adult content is categorized under four themes:
1. Bare skin-based: content based on the visual presentation of the human body including parts normally covered by under garments.
2. Act-based: content categorized by actions or activities that are intimate in nature.
. . .
This is a global policy and will be enforced independently of geographical location.
The restricted adult content policy applies to real, digital, and other visual depictions. This policy also applies to headline text.
Content labeled as restricted adult content (even if it is educational, documentary, scientific, artistic, historical, or newsworthy) will be less visible in prominent positions but not rejected.

### Listing 1—Example Image Regulation Policy

The image moderation system 210 may employ any number of regulated image or content policies. For example, while a restricted adult content policy is shown, the image moderation system 210 may also use a prohibited adult content policy that defines prohibited adult content along with instructions to prevent an image search system from serving those images.

The multi-stage framework 300 includes an image retrieval stage 400 (e.g., a vector-based image retrieval stage). In this stage, the image moderation system 210 utilizes the regulated image policy 308 along with a generative AI model to generate image search queries based on regulated images identified in the policy. The image moderation system 210 then utilizes the image search queries with an image search system to obtain an initial set of image results corresponding to the regulated image policy. Additional details about using a generative AI model and an image search system to retrieve regulated images are provided below in connection with FIG. 4.

The multi-stage framework 300 includes an image relevance stage 500 (e.g., a vector-based image relevance stage). In various implementations, the image moderation system 210 filters out noisy and irrelevant images within the image search results and/or images obtained from the image catalog 134. For example, the image moderation system 210 utilizes vector embedding comparisons between the image search queries for the regulated images and the images in the search results, and from the image catalog in some cases, to determine which images are relevant. Furthermore, the image moderation system 210 may generate a training dataset by combining the relevant images with some or all of the images from the image catalog 134. Additional details regarding the identification of relevant images and generating a training dataset with regulated images are provided below in connection with FIG. 5.

The multi-stage framework 300 includes a dataset classification stage 600. In this stage, the image moderation system 210 utilizes a generative AI model to label or relabel the images in the training dataset. For example, the image moderation system 210 provides a classification prompt with the images in the training dataset to a visual-based generative AI model with instructions for the model to classify each image in the dataset. In some instances, the image moderation system 210 also provides the regulated image policy 308 and/or image metadata and/or multimodal embeddings to the model. The image moderation system 210 then associates the generated classified labels with the images to create a labeled training dataset of images 340. Additional details about using a visual-based generative AI model to generate labeled training datasets are provided below in connection with FIG. 6.

As mentioned above, FIG. 4 provides additional details about using a generative AI model and an image search system to retrieve regulated images and generate a vector embedding database of a training dataset with regulated images. In particular, FIG. 4 illustrates an example diagram for generating a vector embedding database using a generative AI model, an image search system, and an embedding encoder according to some implementations. As shown, FIG. 4 includes the image retrieval stage 400 performed by, or in association with, the image moderation system 210.

As shown, the image retrieval stage 400 includes a regulated image policy 402. As mentioned, the image moderation system 210 may identify one or more regulated image policies for which to obtain sets of image results. Policies may include prohibited images, restricted images, or permitted images. In some instances, a regulated image policy includes rules, guidelines, and/or conditions for multiple types and/or degrees of regulated images. For example, a regulated image policy corresponding to cartoon violence can indicate types of images that are prohibited, restricted, or permitted.

In various implementations, the image moderation system 210 generates prompts based on the regulated image policy 402 to provide to the generative AI model 140. The image retrieval stage 400 includes a search query generation prompt 404. In various implementations, the search query generation prompt 404 includes a set of instructions that directs the generative AI model to create a set of image search queries (e.g., one or more terms) that, when searched by an image search system, identify images that violate the regulated image policy.

Listing 2 below provides an example of a search query generation prompt corresponding to violent content:
I'm working on a research project to help moderate certain content and need to find images that clearly answer “yes” to specific questions. The goal is to collect images that will help train a model to moderate content effectively. Your task is to identify search terms that, if used to search for images, will answer specific questions affirmatively. To do this effectively, you first need to consider all situations where these questions can occur.
Guidelines for search term generation:
   1. In case the question is complicated, break it down into multiple questions.
   2. Brainstorm possible scenarios where the answer would be “yes.”
   3. Convert the scenarios into specific search terms that can be used to retrieve relevant images.
   4. Ensure the terms are clear and specific to avoid irrelevant results.
Example:
Question: Does the image contain violence?
Scenarios: Images of physical fights, weapons, blood, injuries, etc.
Search Terms: [“violent images,” “graphic content,” “images of fights,” “weapon-related images”]
Please identify the search terms for the following question: Question: {Question}
Answer in the format of Search Terms: [“Terms1,” “Terms2,” “Terms3,” etc.]

### Listing 2—Example Search Query Generation Prompt

In one or more implementations, the image moderation system 210 prompts the generative AI model 140 to generate a set of questions from the regulated image policy 402, such as questions about violating the policy. The image moderation system 210 may then provide the questions in another prompt to the generative AI model 140 to generate image search queries (e.g., search terms) that would identify images that answer or correspond to the questions. An image search query can include one or more of the search terms. In some implementations, the generative AI model 140 generates natural-language phrases that include or are based on the generated terms.

In some instances, the image moderation system 210 creates the search query generation prompt 404 to include a set of instructions that directs the generative AI model to perform multiple steps. The steps can include identifying one or more image classifications (e.g., regulated classifications) from the regulated image policy. The steps can also include determining scenarios that include images that would violate the regulated image policy based on having the identified image classifications. Additionally, the steps can include determining terms that correspond to those images that have the one or more image classifications and/or would violate the regulated image policy. Furthermore, the steps include generating a set of image search queries that include the identified terms, which can be used to identify images that would have the one or more image classifications.

These steps can be provided in a single prompt or divided among multiple prompts. For example, the image moderation system 210 provides each step in a separate prompt with processing occurring at the image moderation system 210 between one or more of the prompts. In some implementations, a prompt includes multiple steps. Additionally, the prompt may include example outputs of questions, terms, or search queries.

Overall, the image moderation system 210 utilizes the generative AI model 140 to generate a set of image search queries 406, which can include terms that will retrieve images that would violate the regulated image policy and/or would be classified into a regulated classification. When using text queries, the image moderation system 210 can generate the set of image search queries 406, even at large scales, automatically and with little to no human intervention.

The image retrieval stage 400 also includes the image search system 106. For example, the image moderation system 210 provides the set of image search queries 406 to the image search system 106 to execute the image search queries. In response, the image search system 106 returns regulated image search results 408. For example, the regulated image search results 408 include images matching the generated terms that would violate the regulated content policy and/or would be classified with regulated image classification. In some instances, the image search system 106 may provide the set of image search queries 406 to the image search system 106 as a batch to receive multiple sets of the regulated image search results 408 around the same time.

In some implementations, the image moderation system 210 collects at least a minimum number of images for each image search result. In various implementations, the image moderation system 210 collects a predetermined number of images from the image search results for an image search query. For example, the image moderation system 210 collects the top n (e.g., 100) images for each image search query in the set of image search queries. In some implementations, the image moderation system 210 increases or decreases the number of collected images from the image results.

In various implementations, the image moderation system 210 combines the image search results for all of the image search queries into a combined set of images. Additionally, in some implementations, the image moderation system 210 removes duplicate images from the combined set of images to obtain a filtered set of images for the regulated image classification.

As described further below, the regulated image search results 408 often include irrelevant or noisy images. For example, the regulated image search results 408 may include any number of permitted images. Furthermore, the image search system 106 may attempt to filter out prohibited images, or there may be a lack of prohibited images to serve. In some instances, the image moderation system 210 may collect an additional number of images (e.g., 150 images rather than 100 images) to accommodate the limited selection of a regulated classification.

In various implementations, the image moderation system 210 may use image similarity to identify additional related images. For example, the image moderation system 210 requests the image search system 106 to perform an image similarity search on one or more of the top results from the text search query.

In one or more implementations, the image moderation system 210 also collects metadata corresponding to the regulated image search results 408. For example, if a retrieved image is associated with a website, the image moderation system 210 can collect and associate website data, such as the website address, title, header, and included content. In some instances, if there is text associated with the image, the image moderation system 210 stores a copy of the text alongside the image.

Upon obtaining the regulated image search results 408, in some instances, the image moderation system 210 generates a vector embedding database. To illustrate, the image retrieval stage 400 includes the image moderation system 210 combining images from an image catalog 144 (e.g., image datastore) with the regulated image search results 408. In various implementations, the image moderation system 210 takes a random image sample 410 from the image catalog 144. In particular, the image moderation system 210 takes a random subset of the image catalog 144 that maintains the same or similar content distribution as the image catalog 144.

According to some implementations, the image moderation system 210 only obtains images from the image catalog 144 without any context data (e.g., no labels, no metadata, no categories). In some implementations, the image moderation system 210 also receives additional context and/or text data (e.g., metadata or labels) associated with each image from the image catalog 144. In some implementations, the image moderation system 210 selects most or all images in the image catalog 144. In some implementations, the image moderation system 210 selects images from multiple image catalogs and/or other data sources.

As shown, the image retrieval stage 400 includes generating image embeddings 412 of the obtained images using an embedding encoder 120. In various implementations, the embedding encoder 120 is a multimodal embedding encoder model that generates feature vectors in a vector embedding space from the images. For images in the image catalog 144, the image moderation system 210 can generate the encoding based on the images themselves. In some instances, the image embedding is also based on additional content stored with each image.

For images in the regulated image search results 408, the image search query can also encode the regulated images with the image search query used to identify them. In some instances, the image moderation system 210 also bases the encoding on image data associated with the images. By encoding both image and text data in a multimodal embedding, the image moderation system 210 allows for a more accurate representation of the images in feature vector embedding space.

The image retrieval stage 400 includes generating an image index 414 from the image embeddings. For instance, the image moderation system 210 sorts and organizes the image embeddings 412 for the regulated image search results 408 and the sampled images from the search queries 114. Furthermore, the image moderation system 210 can generate the vector embedding database 132 to maintain the embeddings and/or the image index 414.

As mentioned above, FIG. 5 provides additional details about using multimodal embeddings to determine relevant regulated retrieved images. In particular, FIG. 5 illustrates an example diagram for determining the top relevant regulated images based on image search results of prohibited images and image search queries according to some implementations. As shown, FIG. 5 corresponds to the image relevance stage 500, which is performed by, or in connection with, the image moderation system 210.

As illustrated, the image relevance stage 500 shows the regulated image policy 402, the search query generation prompt 404, and the set of image search queries 406 (generated by the generative AI model 140), which are described above. For instance, the image moderation system 210 shares the initial steps with the image retrieval stage 400 to generate the set of image search queries 406. Upon generating the set of image search queries 406, the image relevance stage 500 separates from the image retrieval stage 400.

To illustrate, the image relevance stage 500 includes encoding the set of image search queries 406 into the search query embeddings 502 using the embedding encoder 120. For example, the image moderation system 210 utilizes the same multimodal embedding encoding model as that used in the image retrieval stage 400. In some implementations, the embedding encoder 120 is a different encoding model (e.g., a non-multimodal embedding encoder) that encodes to a similar embedding space.

The image relevance stage 500 also includes an image relevance model 504 that compares the search query embeddings 502 to embeddings within the vector embedding database 132 to determine a set of relevant regulated images (e.g., images that violate the regulated image policy 402). For example, to remove noisy or irrelevant images, the image moderation system 210 determines which images correspond to the set of image search queries 406 (and, thus, the regulated image policy 402) and which images are unrelated.

In various implementations, the image moderation system 210 utilizes the image relevance model 504 to map the search query embeddings 502 and the database 132 together to determine which image embeddings are located in close proximity to the search query embeddings 502. In various implementations, the image relevance model 504 utilizes a nearest neighbor algorithm, such as an approximate nearest neighbor (e.g., hierarchical navigable small world (HNSW)) search, which returns the K-nearest neighbors for each of the search query embeddings 502. In one or more implementations, the image relevance model 504 uses KNN or another clustering algorithm. The image moderation system 210 may keep a set number of images from each search or clustering algorithm.

In some implementations, the image moderation system 210 identifies all embeddings within a threshold distance of a search query embedding. In various implementations, the image moderation system 210 utilizes metrics such as cosine similarity, dot product, or Euclidean distance to determine when images are associated with the database 132. Images within the threshold distance to the search query embeddings 502 are maintained as relevant regulated images while images outside the threshold are excluded or dropped.

In some implementations, the image moderation system 210 determines a central location among the search query embeddings 502. Then, the image moderation system 210 determines which images with embeddings in the database 132 are considered relevant based on being within a threshold distance of the central location.

In various implementations, the image moderation system 210 selects a top number of relevant regulated images 506 from the search algorithms and/or groups. The image moderation system 210 can repeat the process for different regulated image policies to ensure that, for each regulated image policy, the image moderation system 210 obtains target images that would violate or fail the corresponding regulated image policy. In some implementations, the image moderation system 210 performs an aggregate comparison of which embeddings in the vector embedding database 132 are closest (or close enough) to the search query embeddings 502.

In some implementations, the image moderation system 210 relates the vector embedding database 132 to image embeddings of just the regulated image search results described above. In these instances, the image moderation system 210 filters out the noisy images from the regulated image search results. In other instances, the image moderation system 210 includes all images in the vector embedding database 132, which can include images sampled from the image catalog.

In various implementations, the image moderation system 210 selects a top number of relevant images from the vector embedding database 132. For example, the image moderation system 210 selects the top 10, 25, 50, or another number of top relevant images that have at least a minimum correlation value with the search query embeddings 502.

In some implementations, the image relevance stage 500 includes utilizing a generative AI model to determine the top number of relevant regulated images 506. For example, the image moderation system 210 provides the set of image search queries 406 and images corresponding to the vector embedding database 132 along with a relevancy comparison prompt. In response, the generative AI model determines the top number of relevant regulated images 506. In some instances, the generative AI model returns a Boolean value of relevant or not relevant for each image.

To illustrate, Listing 3 below shows an example of a relevancy comparison prompt:
You are an expert in information retrieval, and your task is to estimate the relevance of a retrieved image to a query.
More specifically, you will be provided with two pieces of information:
   1. Query, which is the query used to retrieve an image
   2. Retrieved Image, which is the image we want to evaluate
Your task is to predict “Relevant” if the Retrieved Image contains the information required to provide an answer to the Query. Otherwise, you should predict “Not Relevant.”
#####
Here are your inputs:
Query: {query_text}
Retrieved Image: {Image}
#####
Take a step back and reflect carefully on how best to solve your task.
You should provide your answer in the form of a Boolean value: “Relevant” or “Not Relevant.”

### Listing 3—Example Relevancy Comparison Prompt

While the above examples correspond to supplementing image catalog images with underrepresented regulated images, in some implementations, the image moderation system 210 performs similar actions with respect to non-regulated underrepresented images. For example, some cases are occasionally underrepresented in an image catalog because they are falsely flagged as regulated images by the image search system (e.g., images showing open-backed dresses may be flagged as restricted nudity). Thus, in some cases, the image moderation system 210 can ensure that there are sufficient examples of these cases, with permitted classification labels, included in the supplemented training datasets. By doing so, the image moderation system 210 improves the accuracy of real-time classification models to reduce falsely blocking or restricting permitted images.

As mentioned above, FIG. 6 provides additional details about using a visual-based generative AI model to generate labeled training datasets. In particular, FIG. 6 illustrates an example diagram for generating labeled data using a visual-based generative AI model according to some implementations. As shown, FIG. 6 includes the dataset classification stage 600 performed by, or in association with, the image moderation system 210.

The dataset classification stage 600 includes the training dataset of images 130, introduced above. For example, the image moderation system 210 combines the top number of relevant regulated images 506 with a random image sample 410 from the image catalog 144 to create the training dataset of images. Indeed, the image moderation system 210 can add the relevant regulated images that violate the regulated image policy into representative images from the image catalog 144 to create a training dataset that adequately represents the regulated images that were previously underrepresented. In some implementations, the random image sample 410 from the image catalog 144 is the same as, or a different sample from before, as the distribution will still be similar to the overall distribution of the image catalog 144.

The dataset classification stage 600 includes a classification prompt 602. In various implementations, the image moderation system 210 generates a classification prompt 602 for a visual-based generative AI model 145 to generate classification labels for images in the training dataset. To elaborate, upon generating an improved training dataset complete with regulated images and other underrepresented image types, the image moderation system 210 needs to create classification labels for the images in the dataset to make the dataset functional. Accordingly, the image moderation system 210 can use a generative AI model that specializes in image processing to generate classification labels.

In various implementations, the classification prompt 602 includes instructions directing the visual-based generative AI model 145 to analyze a set of guidelines that includes a set of image classifications, analyze each image in the training dataset (e.g., determine the content and context of each image based on its visual features and characteristics), determine which classification each image matches from the set of guidelines, and classify the image with the identified image classification. The visual-based generative AI model 145 then returns the identified image classification for each input image.

In various implementations, the image classifications include prohibited images, restricted images, and permitted images. In some implementations, the classifications include sub-classes, such as types of prohibited images and/or types of restricted images. For example, depending on the audience type and/or set permissions, some users may be permitted to view certain categories of restricted images but not others.

In some implementations, the image moderation system 210 provides the classification prompt 602 to the visual-based generative AI model 145 along with other inputs. For example, the image moderation system 210 provides one or more regulated image policies. In some instances, the image moderation system 210 provides metadata and/or multimodal embedding for the images. In some implementations, classification guidelines are provided as a separate input.

For example, the classification prompt 602 may provide guidelines defining images that include restrictive borderline adult (BLA) content or non-revealing (NR) content with several (e.g., 20 or more) examples of each classification. For illustrative purposes, Listing 4 below provides an example classification prompt between mild videogame violence (MVV) and severe videogame violence (SVV). As with the other example listings, the prompt has been shortened for brevity.
You are an expert in content moderation. You work at a high-standard online news platform. You need to maintain high-quality content. You are tasked with classifying images into one of two categories: Mild Video Violence (MVV) or Severe Video Violence (SVV), based on the following definitions. Carefully review every part of each image closely and determine the appropriate classification according to the guidelines provided. Ignore any text in the image in the description and classification.
#Guidelines:
** Mild Video Violence (MVV) definition start**
An image will be classified as MVV if any part of it includes one or more of the following guidelines:
1. Characters engaging in playful or slapstick actions, such as tripping or slipping on a banana peel.
2. Video game characters involved in non-lethal, humorous fights, like pillow fights or food fights.
3. Characters using comical, non-threatening weapons, such as water guns or foam swords.
. . .
**MVV definition end**
** Severe Video Violence (SVV) definition start**
An image will be classified as SVV if any part of it includes one or more of the following guidelines:
1. Characters engaging in intense physical confrontations, such as fistfights or battles with visible injuries.
2. Use of weapons that cause significant harm, like swords, guns, or explosives, even if depicted in a cartoonish manner.
3. Scenes depicting characters in life-threatening situations, such as being tied up, trapped, or facing imminent danger.
. . .
**SVV definition end**
#Instructions:
1. Review the image carefully.
2. Analyze each one of the guidelines separately.
3. Determine if the image fits the guidelines listed under MVV, SVV, or neither.
4. Classify the image as MVV, SVV, or NV (no violence) based on the guidelines.
Please ensure your classification is accurate and consistent with the guidelines provided.
#Imput Format:
   IMAGE: <<Image URL>>
#Output Format:
   The output should be a JSON with the following fields:
      Image Classification.
      Explanation: The thought process for the classification.
      Image Description: Detailed description of the image.

### Listing 4—Example Classification Prompt

As shown, the dataset classification stage 600 includes the labeled training dataset 142.

For example, the image moderation system 210 pairs the generated label (or labels if classifying multiple regulated categories) with each corresponding image. By doing so, the image moderation system 210 creates a functional, robust training dataset that includes accurate, reliable, and comprehensive ground truth data, especially labeled regulated images.

As mentioned above, FIGS. 7A-7B provide additional detail about training and using classification machine learning models based on labeled training datasets. For instance, FIGS. 7A-7B illustrate example diagrams of training and utilizing a classification machine learning model based on the labeled training dataset according to some implementations. In particular, FIG. 7A corresponds to training a classification machine learning model, while FIG. 7B corresponds to using the trained model to classify images in real time in response to search queries.

As mentioned, FIG. 7A corresponds to training a classification machine learning model according to some implementations. FIG. 7A includes the labeled training dataset 142, a classification machine learning model 710, and a loss model 720. The labeled training dataset 142 includes sample images 704 and sample image labels 706 (e.g., ground truths) for the classification model. In some implementations, the classification machine learning model 710 is a lightweight neural network or another type of lightweight machine learning model.

In various implementations, the classification machine learning model 710 is a convolutional neural network or another type of deep-learning neural network. In one or more implementations, the image moderation system 210 uses supervised learning to train the classification machine learning model 710 based on the sample images 704 and the sample image labels 706 in the labeled training dataset 142.

As one example, in various implementations, the image moderation system 210 provides a sample image to the classification machine learning model 710. The classification machine learning model 710 analyzes the input image and outputs a predicted image classification from a set of predicted image classifications 712.

In this example, the image moderation system 210 utilizes a loss model 720 to compare the set of predicted image classifications 712 with corresponding instances of the sample images 704 to determine whether the classifications match the ground truth labels. Based on the differences, the loss model 720 determines an amount of error or loss. Furthermore, the image moderation system 210 can provide the error amount as label feedback 722 to the classification machine learning model 710 to refine and fine-tune the model.

In various implementations, the loss model 720 may use one or more loss functions. The loss amount is provided back to the classification machine learning model 710 as the label feedback 722 to tune the weights, parameters, layers, and/or nodes of the model. The image moderation system 210 may train the classification machine learning model 710 via backpropagation in an end-to-end manner until the model converges or satisfies another training criterion.

Turning to FIG. 7B, the image moderation system 210 can utilize the trained version of the classification machine learning model 710 to perform real-time classification and image moderation (or moderation of other content). As shown, FIG. 7B includes an image query 730, the image search system 106, real-time image search results 732, the classification machine learning model 710, real-time image classifications 734, and moderated image search results 736.

As shown, the image search system 106 receives the image query 730. For example, a user provides the image query 730 to request images corresponding to the search query. In some implementations, the image query 730 originates from a content management system, such as a news provider, requesting images. In response, the image search system 106 identifies the real-time image search results 732. However, before providing the real-time image search results 732 in response to the image query, the image moderation system 210 moderates the images to remove, hide, blur, or otherwise censor or moderate the image results.

In various implementations, the image moderation system 210 provides the real-time image search results 732 to the classification machine learning model 710 to generate real-time image classifications 734. Because the classification machine learning model 710 is lightweight and trained with a robust training dataset that includes regulated images, the classification machine learning model 710 can quickly, efficiently, and accurately generate real-time image classifications 734. Then, using the real-time image classifications 734, the image moderation system 210 can generate the moderated image search results 736, which the image moderation system 210 and/or the image search system 106 can provide in response to the image query 730.

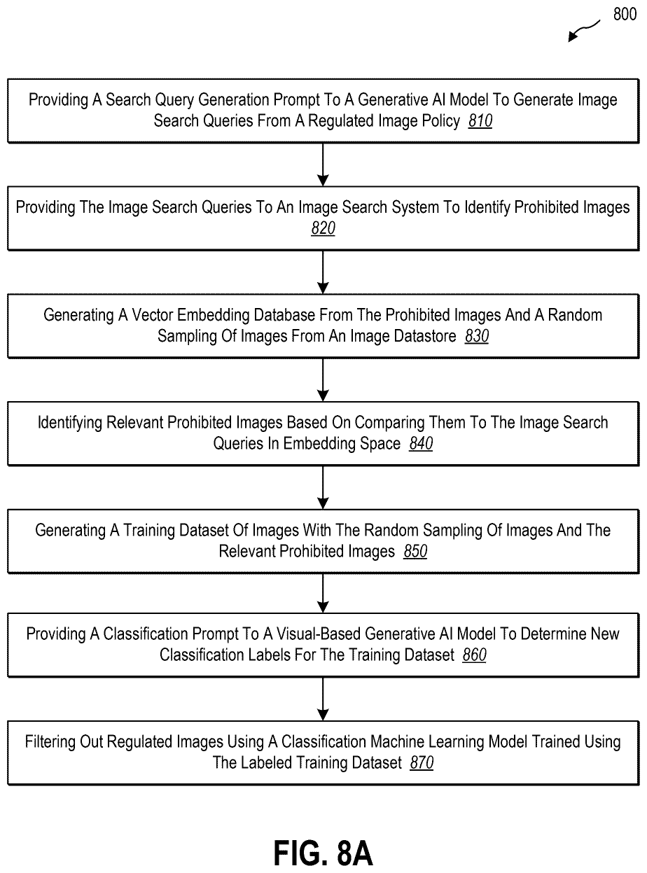

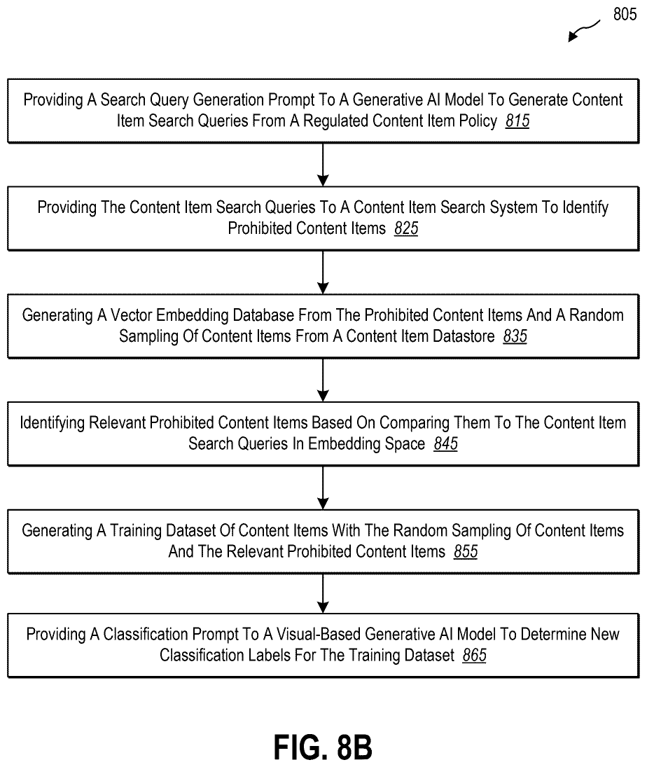

Turning now to FIGS. 8A-8B, these figures illustrate two example series of acts of computer-implemented methods for generating one or more content classification datasets using one or more AI models according to some implementations. For example, FIG. 8A illustrates generating image classification datasets using a generative AI model, and FIG. 8B illustrates generating content item classification datasets using generative AI models. While FIGS. 8A-8B illustrate acts according to one or more implementations, alternative implementations may omit, add to, reorder, and/or modify any of the acts shown.

The acts in FIGS. 8A-8B can be performed as part of a method (e.g., a computer-implemented method). Alternatively, a computer-readable medium can include instructions that, when executed by a processing system with a processor, cause a computing device to perform the acts in FIGS. 8A-8B. In some implementations, a system (e.g., a processing system comprising a processor) can perform the acts in FIGS. 8A-8B. For example, the system includes a processing system and a computer memory including instructions that, when executed by the processing system, cause the system to perform various actions or steps.

Turning to FIG. 8A, this figure includes a series of acts 800 for generating image classification datasets using generative AI models. As shown, the series of acts 800 includes act 810 of providing a search query generation prompt to a generative AI model to generate image search queries from a regulated image policy. For instance, in example implementations, act 810 involves providing a search query generation prompt to a generative AI model to generate a set of image search queries from a regulated image policy, where the set of image search queries is used to identify images having a regulated image classification that is underrepresented in an image datastore. In some instances, generating the search query generation prompt includes providing a set of instructions in the search query generation prompt that directs the generative AI model to create the set of image search queries that, when searched by the image search system, identifies images that violate the regulated image policy based on having the regulated image classification.

In various instances, generating the search query generation prompt includes providing a set of instructions in the search query generation prompt that directs the generative AI model to identify one or more image classifications from the regulated image policy that correspond to inappropriate content items, wherein the one or more image classifications include the regulated image classification, determine scenarios where images would violate the one or more image classifications, determine terms that correspond to the images that would have the one or more image classifications, and generate the set of image search queries with the terms to identify images that would have the one or more image classifications. In one or more implementations, the regulated image policy indicates that images with the regulated image classification are restricted images not permissible to specific user audiences or prohibited images not permissible to any user audience.

As further shown, the series of acts 800 includes act 820 of providing the image search queries to an image search system to identify prohibited images. For instance, in example implementations, act 820 involves providing the set of image search queries to an image search system to identify sets of images corresponding to each image search query in the set of image search queries. In various implementations, act 820 includes receiving a minimum number of images for each image search query corresponding to the regulated image classification from the image search system, combining the minimum number of images for each image search query into a combined set of images, and removing duplicate images in the combined set of images to obtain a filtered set of images for the regulated image classification.

As further shown, the series of acts 800 includes act 830 of generating a vector embedding database from the prohibited images and a random sampling of images from an image datastore. For instance, in example implementations, act 830 involves generating a vector embedding database that includes vector embeddings generated from the sets of images and from a random image subset from the image datastore. In one or more implementations, act 830 includes identifying the random image subset by querying the image datastore for a random sampling of images from a recent time period, where the random image subset includes image metadata associated with one or more images in the random image subset.

In some implementations, generating the vector embedding database includes generating a first set of multimodal embeddings from the sets of images using a multimodal embedding encoder, generating a second set of multimodal embeddings from the random image subset using the multimodal embedding encoder, mapping the first set of multimodal embeddings and the second set of multimodal embeddings to a multimodal vector embedding space, and indexing multimodal embeddings in the multimodal vector embedding space into the vector embedding database. In various implementations, generating the first set of multimodal embeddings includes encoding each image in the sets of images with its corresponding image search query.

As shown further, the series of acts 800 includes act 840 of identifying relevant prohibited images based on comparing them to the image search queries in embedding space. For instance, in example implementations, act 840 involves identifying a set of relevant images with the regulated image classification based on comparing search query embeddings of the set of image search queries with the vector embeddings in the vector embedding database. In various implementations, act 840 includes generating the search query embeddings by encoding the set of image search queries using the multimodal embedding encoder. In some instances, identifying the set of relevant images with the regulated image classification includes comparing the search query embeddings with the vector embeddings to identify a subset of vector embeddings that are associated with the search query embeddings, and images corresponding to the subset of vector embeddings are included in the set of relevant images. In some implementations, identifying the subset of vector embeddings that are associated with the search query embeddings includes using a nearest neighbor algorithm based on the search query embeddings.

As shown further, the series of acts 800 includes act 850 of generating a training dataset of images with the random sampling of images and the relevant prohibited images. For instance, in example implementations, act 850 involves generating a training dataset of images by combining the random image subset with the set of relevant images. In some instances, act 850 includes generating a training dataset of images based on the set of relevant images. In one or more implementations, the set of relevant images excludes noisy images from the sets of images found by the image search system using the set of image search queries that do not belong to the regulated image classification, and the training dataset excludes the noisy images found by the image search system using the set of image search queries.

As shown further, the series of acts 800 includes act 860 of providing a classification prompt to a visual-based generative AI model to determine new classification labels for the training dataset. For instance, in example implementations, act 860 involves providing a classification prompt to a visual-based generative AI model to determine new classification labels for the images in the training dataset to generate a labeled training dataset. In some implementations, act 860 includes generating the classification prompt to include a set of instructions directing the visual-based generative AI model to analyze a set of guidelines that includes a set of image classifications, analyze each image in the training dataset, determine that an image matches a guideline of the set of guidelines, and classify the image with an image classification that corresponds to the guideline.

As shown further, the series of acts 800 includes act 870 of filtering out regulated images using a classification machine learning model trained using the labeled training dataset. For instance, in example implementations, act 870 involves filtering out regulated images in a real-time image search using a classification machine learning model trained using the labeled training dataset. In one or more implementations, act 870 includes filtering out images in real-time using a classification machine learning model trained using the images in the training dataset. In some instances, act 870 includes identifying a set of relevant images with the regulated image classification based on comparing search query embeddings of the set of image search queries with multimodal embeddings of the sets of images.

In various implementations, the series of acts 800 can include various additional acts. For example, the series of acts 800 includes training the classification machine learning model using the training dataset with the new classification labels to classify images in real time according to a set of image classifications. In some instances, the series of acts 800 includes receiving a request to provide an image, classifying the image in real time using the classification machine learning model as a prohibited image, and blocking the request based on the image being classified as a prohibited image. In one or more implementations, the series of acts 800 includes training the classification machine learning model using the labeled training dataset to classify images in real time according to a set of image classifications.

Turning to FIG. 8B, this figure includes a series of acts 805 for generating content item classification datasets using a generative AI model.

As shown, the series of acts 805 includes act 815 of providing a search query generation prompt to a generative AI model to generate content item search queries from a regulated content item policy. For instance, in example implementations, act 815 involves providing a search query generation prompt to a generative AI model to generate a set of content item search queries from a regulated content policy, where the set of content item search queries is used to identify content items having a regulated content item classification underrepresented in a content item datastore.

As further shown, the series of acts 805 includes act 825 of providing the content item search queries to a content item search system to identify prohibited content items. For instance, in example implementations, act 825 involves providing the set of content item search queries to a content item search system to identify sets of content items corresponding to each content item search query in the set of content item search queries.

As further shown, the series of acts 805 includes act 835 of generating a vector embedding database from the prohibited content items and a random sampling of content items from a content item datastore. For instance, in example implementations, act 835 involves generating a vector embedding database that includes vector embeddings generated from the sets of content items and from a random content item subset from the content item datastore.

As shown further, the series of acts 805 includes act 845 of identifying relevant prohibited content items based on comparing them to the content item search queries in embedding space. For instance, in example implementations, act 845 involves identifying a set of relevant content items with the regulated content item classification based on comparing search query embeddings of the set of content item search queries with the vector embeddings in the vector embedding database.

As shown further, the series of acts 805 includes act 855 of generating a training dataset of content items with the random sampling of content items and the relevant prohibited content items. For instance, in example implementations, act 855 involves generating a training dataset by combining the random content item subset with the set of relevant content items.

As shown further, the series of acts 805 includes act 865 of providing a classification prompt to a visual-based generative AI model to determine new classification labels for the training dataset. For instance, in example implementations, act 865 involves providing a classification prompt to a visual-based generative AI model to determine new classification labels for sample content items in the training dataset to generate a labeled training dataset. In various implementations, the series of acts 865 also includes filtering out regulated images in real time using a classification machine learning model trained with the labeled training dataset. In some instances, the sets of content items include sets of images.

In various implementations, the series of acts 805 can include additional acts. For example, the series of acts 805 includes filtering out regulated content items using a classification machine learning model trained with the labeled training dataset.

FIG. 9 illustrates certain components that may be included within a computer system 900. The computer system 900 may be used to implement the various computing devices, components, and systems described herein (e.g., by performing computer-implemented instructions). As used herein, a “computing device” refers to electronic components that perform a set of operations based on a set of programmed instructions. Computing devices include groups of electronic components, client devices, server devices, etc.

In various implementations, the computer system 900 represents one or more of the client devices, server devices, or other computing devices described above. For example, the computer system 900 may refer to various types of network devices capable of accessing data on a network, a cloud computing system, or another system. For instance, a client device may refer to a mobile device such as a mobile telephone, a smartphone, a personal digital assistant (PDA), a tablet, a laptop, or a wearable computing device (e.g., a headset or smartwatch). A client device may also refer to a non-mobile device such as a desktop computer, a server node (e.g., from another cloud computing system), or another non-portable device.

The computer system 900 includes a processing system including a processor 901. The processor 901 may be a general-purpose single-or multi-chip microprocessor (e.g., an Advanced Reduced Instruction Set Computer (RISC) Machine (ARM)), a special-purpose microprocessor (e.g., a digital signal processor (DSP)), a microcontroller, a programmable gate array, etc. The processor 901 may be referred to as a central processing unit (CPU) and may cause computer-implemented instructions to be performed. Although the processor 901 shown is just a single processor in the computer system 900 of FIG. 9, in an alternative configuration, a combination of processors (e.g., an ARM and DSP) could be used.

The computer system 900 also includes memory 903 in electronic communication with the processor 901. The memory 903 may be any electronic component capable of storing electronic information. For example, the memory 903 may be embodied as random-access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM), registers, and so forth, including combinations thereof.

The instructions 905 and the data 907 may be stored in the memory 903. The instructions 905 may be executable by the processor 901 to implement some or all of the functionality disclosed herein. Executing the instructions 905 may involve the use of the data 907 that is stored in the memory 903. Any of the various examples of modules and components described herein may be implemented, partially or wholly, as instructions 905 stored in memory 903 and executed by the processor 901. Any of the various examples of data described herein may be among the data 907 that is stored in memory 903 and used during the execution of the instructions 905 by the processor 901.

A computer system 900 may also include one or more communication interface(s) 909 for communicating with other electronic devices. The one or more communication interface(s) 909 may be based on wired communication technology, wireless communication technology, or both. Some examples of the one or more communication interface(s) 909 include a Universal Serial Bus (USB), an Ethernet adapter, a wireless adapter that operates according to an Institute of Electrical and Electronics Engineers (IEEE) 902.11 wireless communication protocol, a Bluetooth® wireless communication adapter, and an infrared (IR) communication port.

A computer system 900 may also include one or more input device(s) 911 and one or more output device(s) 913. Some examples of the one or more input device(s) 911 include a keyboard, mouse, microphone, remote control device, button, joystick, trackball, touchpad, and light pen. Some examples of the one or more output device(s) 913 include a speaker and a printer. A specific type of output device that is typically included in a computer system 900 is a display device 915. The display device 915 used with implementations disclosed herein may utilize any suitable image projection technology, such as liquid crystal display (LCD), light-emitting diode (LED), gas plasma, electroluminescence, or the like. A display controller 917 may also be provided, for converting data 907 stored in the memory 903 into text, graphics, and/or moving images (as appropriate) shown on the display device 915.

The various components of the computer system 900 may be coupled together by one or more buses, which may include a power bus, a control signal bus, a status signal bus, a data bus, etc. For clarity, the various buses are illustrated in FIG. 9 as a bus system 919.

This disclosure describes a subjective data application system in the framework of a network. In this disclosure, a “network” refers to one or more data links that enable electronic data transport between computer systems, modules, and other electronic devices. A network may include public networks such as the Internet as well as private networks. When information is transferred or provided over a network or another communication connection (either hardwired, wireless, or both), the computer correctly views the connection as a transmission medium. Transmission media can include a network and/or data links that carry required program code in the form of computer-executable instructions or data structures, which can be accessed by a general-purpose or special-purpose computer. Combinations of the above are also included within the scope of computer-readable media.

In addition, the network described herein may represent a network or a combination of networks (such as the Internet, a corporate intranet, a virtual private network (VPN), a local area network (LAN), a wireless local area network (WLAN), a cellular network, a wide area network (WAN), a metropolitan area network (MAN), or a combination of two or more such networks) over which one or more computing devices may access the various systems described in this disclosure. Indeed, the networks described herein may include one or multiple networks that use one or more communication platforms or technologies for transmitting data. For example, a network may include the Internet or other data link that enables transporting electronic data between respective client devices and components (e.g., server devices and/or virtual machines thereon) of the cloud computing system.

Further, upon reaching various computer system components, program code means in the form of computer-executable instructions or data structures can be transferred automatically from transmission media to non-transitory computer-readable storage media (devices), or vice versa. For example, computer-executable instructions or data structures received over a network or data link can be buffered in random-access memory (RAM) within a network interface module (NIC), and then it is eventually transferred to computer system RAM and/or to less volatile computer storage media (devices) at a computer system. Thus, it should be understood that computer-readable storage media (devices) can be included in computer system components that also (or even primarily) utilize transmission media.

Computer-executable instructions include instructions and data that, when executed by a processor, cause a general-purpose computer, special-purpose computer, or special-purpose processing device to perform a certain function or group of functions. In some implementations, computer-executable and/or computer-implemented instructions are executed by a general-purpose computer to turn the general-purpose computer into a special-purpose computer implementing elements of the disclosure. The computer-executable instructions may include, for example, binaries, intermediate format instructions such as assembly language, or even source code. Although the subject matter has been described in language specific to structural features and/or methodological acts, it is to be understood that the subject matter defined in the appended claims is not necessarily limited to the features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or a combination of hardwired and wireless data links) through a network, both perform tasks. In a distributed system environment, program modules may be located in both local and remote memory storage devices.

The techniques described herein may be implemented in hardware, software, firmware, or any combination thereof unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium, including instructions that, when executed by at least one processor, perform one or more of the methods described herein (including computer-implemented methods). The instructions may be organized into routines, programs, objects, components, data structures, etc., which may perform particular tasks and/or implement particular data types, and which may be combined or distributed as desired in various implementations.

Computer-readable media can be any available media that can be accessed by a general-purpose or special-purpose computer system. Computer-readable media that store computer-executable instructions are non-transitory computer-readable storage media (devices). Computer-readable media that carry computer-executable instructions are transmission media. Thus, by way of example, implementations of the disclosure can include at least two distinctly different kinds of computer-readable media: non-transitory computer-readable storage media (devices) and transmission media.

As used herein, computer-readable storage media (devices) may include RAM, ROM, EEPROM, CD-ROM, solid-state drives (SSDs) (e.g., based on RAM), Flash memory, phase-change memory (PCM), other types of memory, other optical disk storage, magnetic disk storage or other magnetic storage devices, or any other medium which can be used to store desired program code means in the form of computer-executable instructions or data structures and which can be accessed by a general-purpose or special-purpose computer.

The steps and/or actions of the methods described herein may be interchanged with one another without departing from the scope of the claims. In other words, unless a specific order of steps or actions is required for the proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a data repository, or another data structure), ascertaining, and the like. Also, “determining” can include receiving (e.g., receiving information), accessing (e.g., accessing data in a memory), and the like. Also, “determining” can include resolving, selecting, choosing, establishing, and the like.

The terms “comprising,” “including,” and “having” are intended to be inclusive and mean that there may be additional elements other than the listed elements. Additionally, it should be understood that references to “one implementation” or “implementations” of the present disclosure are not intended to be interpreted as excluding the existence of additional implementations that also incorporate the recited features. For example, any element or feature described concerning an implementation herein may be combinable with any element or feature of any other implementation described herein, where compatible.

The present disclosure may be embodied in other specific forms without departing from its spirit or characteristics. The described implementations are to be considered illustrative and not restrictive. The scope of the disclosure is indicated by the appended claims rather than by the foregoing description. Changes that come within the meaning and range of equivalency of the claims are to be embraced within their scope.

What is claimed is:

1. A computer-implemented method for generating one or more image classification datasets using one or more generative artificial intelligence (AI) models, comprising:
providing a search query generation prompt to a generative AI model to generate a set of image search queries from a regulated image policy, wherein the set of image search queries is used to identify images having a regulated image classification that is underrepresented in an image datastore;
providing the set of image search queries to an image search system to identify sets of images corresponding to the set of image search queries;
generating a vector embedding database that includes vector embeddings generated from the sets of images and from a random image subset from the image datastore;
identifying a set of relevant images with the regulated image classification based on comparing search query embeddings of the set of image search queries with the vector embeddings in the vector embedding database;
generating a training dataset of images by combining the random image subset with the set of relevant images;
providing a classification prompt to a visual-based generative AI model to determine new classification labels for the images in the training dataset to generate a labeled training dataset; and
filtering out regulated images in real time using a classification machine learning model trained using the labeled training dataset.

2. The computer-implemented method of claim 1, wherein generating the search query generation prompt includes providing a set of instructions in the search query generation prompt that directs the generative AI model to create the set of image search queries that, when searched by the image search system, identifies images that violate the regulated image policy based on having the regulated image classification.

3. The computer-implemented method of claim 1, wherein generating the search query generation prompt includes providing a set of instructions in the search query generation prompt that directs the generative AI model to:
identify one or more image classifications from the regulated image policy that correspond to regulated images, wherein the one or more image classifications include the regulated image classification;
determine scenarios where images would have the one or more image classifications;
determine terms that correspond to the images that have the one or more image classifications; and
generate the set of image search queries with the terms to identify images that would have the one or more image classifications.

4. The computer-implemented method of claim 1, wherein the regulated image policy indicates that images with the regulated image classification are:
restricted images not permissible to specific user audiences; or
prohibited images not permissible to any user audience.

5. The computer-implemented method of claim 1, further comprising:
receiving a minimum number of images for each image search query corresponding to the regulated image classification from the image search system;
combining the minimum number of images for each image search query into a combined set of images; and
removing duplicate images in the combined set of images to obtain a filtered set of images for the regulated image classification.

6. The computer-implemented method of claim 1, further comprising identifying the random image subset by querying the image datastore for a random sampling of images from a recent time period, wherein the random image subset includes image metadata associated with one or more images in the random image subset.

7. The computer-implemented method of claim 1, wherein generating the vector embedding database includes:
generating a first set of multimodal embeddings from the sets of images using a multimodal embedding encoder;
generating a second set of multimodal embeddings from the random image subset using the multimodal embedding encoder;
mapping the first set of multimodal embeddings and the second set of multimodal embeddings to a multimodal vector embedding space; and
indexing multimodal embeddings in the multimodal vector embedding space into the vector embedding database.

8. The computer-implemented method of claim 7, wherein generating the first set of multimodal embeddings includes encoding each image in the sets of images with its corresponding image search query.

9. The computer-implemented method of claim 7, further comprising generating the search query embeddings by encoding the set of image search queries using the multimodal embedding encoder.

10. The computer-implemented method of claim 1, wherein:
identifying the set of relevant images with the regulated image classification includes comparing the search query embeddings with the vector embeddings to identify a subset of vector embeddings that are associated with the search query embeddings; and
images corresponding to the subset of vector embeddings are included in the set of relevant images.

11. The computer-implemented method of claim 10, wherein identifying the subset of vector embeddings that are associated with the search query embeddings includes using a nearest neighbor algorithm based on the search query embeddings.

12. The computer-implemented method of claim 1, wherein:
the set of relevant images excludes noisy images from the sets of images found by the image search system using the set of image search queries that do not belong to the regulated image classification; and
the training dataset excludes the noisy images found by the image search system using the set of image search queries.

13. The computer-implemented method of claim 1, further comprising generating the classification prompt to include a set of instructions directing the visual-based generative AI model to:
analyze a set of guidelines that includes a set of image classifications;
analyze each image in the training dataset;
determine that an image matches a guideline of the set of guidelines; and
classify the image with an image classification that corresponds to the guideline.

14. The computer-implemented method of claim 1, further comprising training the classification machine learning model using the training dataset with the new classification labels to classify images in real time according to a set of image classifications.

15. The computer-implemented method of claim 14, further comprising:
receiving a request to provide an image;
classifying the image in real time using the classification machine learning model as a prohibited image; and
blocking the request based on the image being classified as a prohibited image.

16. The computer-implemented method of claim 1, further comprising training the classification machine learning model using the labeled training dataset to classify images in real time according to a set of image classifications.

17. A system comprising:
a processing system; and
a computer memory comprising instructions that, when executed by the processing system, cause the system to perform operations of:
providing a search query generation prompt to a generative AI model to generate a set of image search queries from a regulated image policy, wherein the set of image search queries is used to identify images having a regulated image classification that is underrepresented in an image datastore;
providing the set of image search queries to an image search system to identify sets of images corresponding to each of the set of image search queries;
generating a vector embedding database that includes vector embeddings generated from the sets of images and from a random image subset from the image datastore;
identifying a set of relevant images with the regulated image classification based on comparing search query embeddings of the set of image search queries with the vector embeddings in the vector embedding database;
generating a training dataset of images by combining the random image subset with the set of relevant images; and
providing a classification prompt to the generative AI model to determine new classification labels for the images in the training dataset to generate a labeled training dataset.

18. The system of claim 17, further comprising additional instructions that, when executed by the processing system, cause the system to perform an operation of training a classification machine learning model using the labeled training dataset to classify images in real time according to a set of image classifications.

19. A computer-implemented method for generating one or more image classification datasets using one or more generative artificial intelligence (AI) models, comprising:
providing a search query generation prompt to a generative AI model to generate a set of image search queries from a regulated image policy, wherein the set of image search queries is used to identify images having a regulated image classification that is underrepresented in an image datastore;
providing the set of image search queries to an image search system to identify sets of images corresponding to each of the set of image search queries;
identifying a set of relevant images with the regulated image classification based on comparing search query embeddings of the set of image search queries with multimodal embeddings of the sets of images;
generating a training dataset of images based on the set of relevant images; and
filtering out images in real time using a classification machine learning model trained using the images in the training dataset.

20. The computer-implemented method of claim 19, further comprising providing a classification prompt to a visual-based generative AI model to determine new classification labels for the set of relevant images in the training dataset to generate a labeled training dataset.
